(19) United States
(12) Patent Application Publication
(10) Pub. No.: US 2021/0380448 A1
(43) Pub. Date: Dec. 9, 2021

(54) BUBBLE GENERATOR

(71) Applicant: Murata Manufacturing Co., Ltd., Nagaokakyo-shi (JP)

(72) Inventors: Katsumi FUJIMOTO, Nagaokakyo-shi (JP); Yoshihiro KOGI, Nagaokakyo-shi (JP)

(21) Appl. No.: 17/408,636

(22) Filed: Aug. 23, 2021

Related U.S. Application Data
(63) Continuation of application No. PCT/JP2020/009071, filed on Mar. 4, 2020.

(30) Foreign Application Priority Data
Mar. 19, 2019 (JP) 2019-050879

(51) Int. Cl. C02F 1/78; B01F 11/00; B01F 3/04; C02F 1/32

(52) U.S. Cl. CPC C02F 1/78; B01F 11/0045; C02F 2303/04; C02F 1/325; B01F 2215/0052; B01F 3/04106

(57) ABSTRACT

A bubble generator includes a diaphragm, a piezoelectric vibrator, and a light source. The diaphragm includes multiple micro apertures, a first surface to be in contact with the water in the water tank and a second surface to be in contact with the gas. The diaphragm transmits ultraviolet light. The piezoelectric vibrator vibrates the diaphragm. The light source emits ultraviolet light to the water in the water tank from a side region of the diaphragm near the other surface.

### CROSS REFERENCE TO RELATED APPLICATIONS

This application claims the benefit of priority to Japanese Patent Application No. 2019-050879 filed on Mar. 19, 2019 and is a Continuation Application of PCT Application No. PCT/JP2020/009071 filed on Mar. 4, 2020. The entire contents of each application are hereby incorporated herein by reference.

### BACKGROUND OF THE INVENTION

### 1. Field of the Invention

The present disclosure relates to a bubble generator.

### 2. Description of the Related Art

In recent years, micro bubbles have been used in various fields, for example, in water purification, wastewater treatment, or fish raising. Bubble generators to generate micro bubbles have been developed (e.g., Japanese Patent No. 6108526).

A bubble generator described in Japanese Patent No. 6108526 utilizes a piezoelectric device to generate micro bubbles. A bubble generator described in Japanese Unexamined Patent Application Publication No. 2018-094543 includes a gas introducing section in which ozone is generated by irradiation of deep ultraviolet light and introduced into a liquid. The introduction of ozone generates micro bubbles.

In the case of generating micro bubbles containing ozone as is in Japanese Unexamined Patent Application Publication No. 2018-094543, it is necessary to provide the bubble generator with the gas introducing section capable of deep ultraviolet irradiation. This may lead to a problem that the size of the bubble generator increases. Moreover, providing the gas introducing section with an ability of the deep ultraviolet irradiation leads to an increase in the cost of the bubble generator.

### SUMMARY OF THE INVENTION

Preferred embodiments of the present invention provide compact and low-cost bubble generators that are each able to generate micro bubbles including ozone.

A bubble generator according to a preferred embodiment of the present disclosure generates micro bubbles in a liquid by vibration. The bubble generator includes a diaphragm including cavities, a first surface to be in contact with the liquid in a liquid tank and a second surface to be in contact with a gas. The diaphragm transmits ultraviolet light. The bubble generator also includes a piezoelectric vibrator to vibrate the diaphragm and a light source to emit the ultraviolet light to the liquid in the liquid tank from a side region of the diaphragm near the second surface.

The bubble generators according to preferred embodiments of the present disclosure are each able to emit ultraviolet light to the liquid of the liquid tank from the second side region of the diaphragm that transmits ultraviolet light. With this configuration, the cost and the size of the bubble generators that are each able to generate micro bubbles containing ozone can be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic view illustrating a water purifier in which a bubble generator according to Preferred Embodiment 1 of the present invention is provided.

FIG. 2 is a perspective view illustrating the bubble generator according to Preferred Embodiment 1 of the present invention.

FIG. 3 is a cross-sectional view illustrating a half section of the bubble generator according to Preferred Embodiment 1 of the present invention.

FIG. 4 is a plan view illustrating a diaphragm according to Preferred Embodiment 1 of the present invention.

FIG. 5 is a cross-sectional view illustrating a cavity formed through the diaphragm according to Preferred Embodiment 1 of the present invention.

FIG. 6 is a schematic view illustrating a water purifier in which a bubble generator according to Preferred Embodiment 2 of the present invention is used.

### DETAILED DESCRIPTION OF THE PREFERRED EMBODIMENT

Bubble generators according to preferred embodiments of the present invention will be described in detail with reference to the drawings. The same or equivalent elements will be denoted by the same reference signs and the description will not be repeated.

### Preferred Embodiment 1

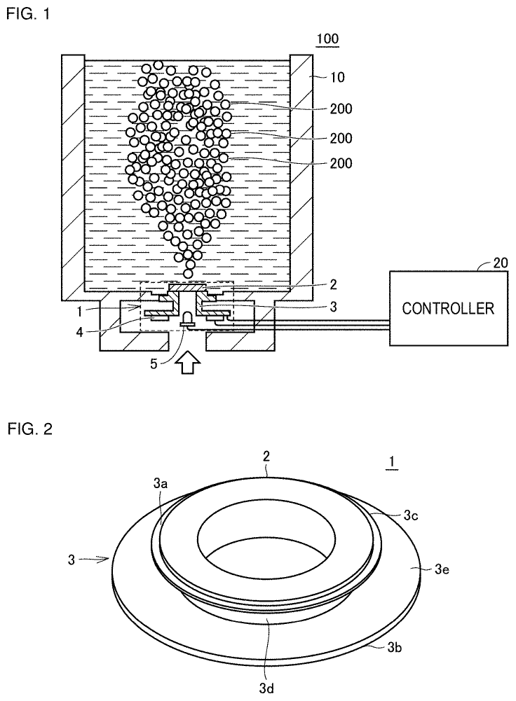

FIG. 1 is a schematic view illustrating a water purifier 100 in which a bubble generator 1 according to Preferred Embodiment 1 of the present invention is provided. For example, the bubble generator 1 of FIG. 1 is used in the water purifier 100 to generate micro bubbles 200 in the water in a water tank (liquid tank) 10. The bubble generator 1 is installed at the bottom of the water tank 10. The application of the bubble generator 1 is not limited to the water purifier 100. The bubble generator 1 may be applied to various apparatuses, such as wastewater treatment apparatuses or fish-raising water tanks, for example.

The bubble generator 1 includes a diaphragm 2, a tube 3, a piezoelectric vibrator 4, and a light source 5. The bubble generator 1 is configured such that the diaphragm 2 is disposed at a hole in a portion of the bottom of the water tank 10 and the piezoelectric vibrator 4 vibrates the diaphragm 2 via the tube 3. Micro bubbles 200 are thus generated at multiple micro apertures (cavities) extending through the diaphragm 2.

For example, the diaphragm 2 is defined by a glass plate that can transmit ultraviolet and deep ultraviolet light having a wavelength of, for example, about 200 nm to about 380 nm. For example, the glass plate is made of silica glass or of synthetic silica glass of which the composition is controlled so as to improve transmission of deep ultraviolet light. Note that the material of the diaphragm 2 is not limited to glass but may be made of other material (for example, a resin) that can transmit ultraviolet light.

The diaphragm 2 includes multiple micro apertures extending therethrough. One surface of the diaphragm 2 is in contact with the water (a liquid) in the water tank 10, and the other surface is in contact with air (a gas). In other words, in the bubble generator 1, the water and the air are partitioned from each other with the diaphragm 2. When back pressure is applied to the other surface of the diaphragm 2 (in a direction indicated by the arrow in FIG. 1) and the diaphragm 2 is vibrated, micro bubbles 200 are generated in the water in the water tank 10 by the air supplied through the micro apertures.

The light source 5 can emit ultraviolet light to the water in the water tank 10 from the side region of the diaphragm 2 near the other surface. The light source 5 is a light source, such as an LED or a mercury lamp, for example, that emits ultraviolet light or deep ultraviolet light. The light source 5 is configured to ozonize oxygen supplied through the micro apertures into the water in the water tank 10 due to the light source 5 emitting ultraviolet light or deep ultraviolet light to the water in the water tank 10. Micro bubbles 200 that include ozonized oxygen have a disinfectant effect.

A portion of ultraviolet light or deep ultraviolet light emitted to the water of the water tank 10 is used to ozonize oxygen supplied into the water, and a portion of it is reflected by the surfaces of the micro bubbles 200 and scattered in the water. In the case of the light source 5 emitting 230 nm ultraviolet light, the ultraviolet light can destroy DNA of bacteria completely. In the bubble generator 1, a back pressure (for example, in a range of about 0.08 to about 0.12 atm or about 8 to about 12 kPa) is applied to the surface of the diaphragm 2 being opposite to the surface in contact with the water (liquid) of the water tank 10. Simultaneously, the light source 5 emits light having a wavelength range of ultraviolet light or deep ultraviolet light. Thus, the water can be sterilized due to both ozone generation and ultraviolet irradiation.

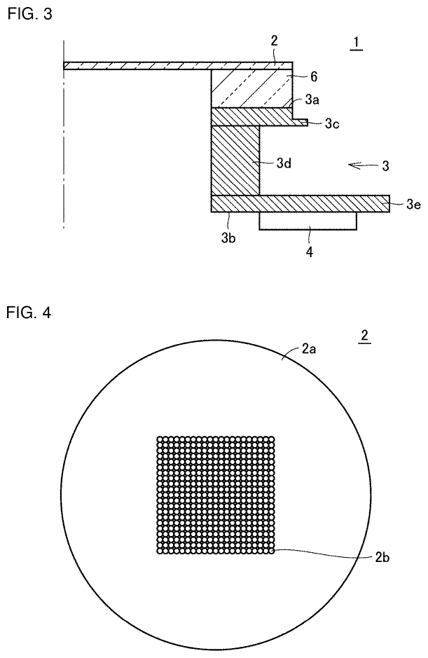

In the bubble generator 1, the piezoelectric vibrator 4 causes the diaphragm 2 to vibrate using the tube 3 interposed therebetween. FIG. 2 is a perspective view illustrating the bubble generator 1 according to Preferred Embodiment 1. FIG. 3 is a cross-sectional view illustrating a half section of the bubble generator according to Preferred Embodiment 1. Note that in FIG. 3, the dash-dot line passes through the central axis of the tube 3.

The tube 3 is connected to the diaphragm 2. The tube 3 is has a tube shape. The tube 3 includes a first end portion 3a and a second end portion 3b that is opposite to the first end portion 3a. The second end portion 3b is positioned opposite to the first end portion 3a in the axial direction of the tube.

The first end portion 3a is connected to the diaphragm 2. In other words, the first end portion 3a of the tube 3 is fixed to the surface of the diaphragm 2 on the side closer to the tube 3 such that the diaphragm 2 closes the opening at the first end portion 3a of the tube 3.

In the present preferred embodiment, the tube 3 is made of stainless steel, for example. The tube 3 may be made of other material. It is preferable that the tube 3 be made of a metal having rigidity, such as stainless steel, for example.

The tube 3 includes a flange 3c extending radially outward from the side surface of the tube 3. For example, as illustrated in FIG. 1, the flange 3c is connected to the hole of the water tank 10 at a portion of the bottom thereof. The first end portion 3a of the tube 3 is thus joined to the water tank 10. When the piezoelectric vibrator 4 causes the diaphragm 2 to vibrate using the tube 3 interposed therebetween, the flange 3c does not vibrate much. Accordingly, the piezoelectric vibrator 4 can vibrate only the diaphragm 2 without transmitting vibrations from the piezoelectric vibrator 4 to the water tank 10.

A ring-shaped collar 3e is provided at the second end portion 3b of the tube 3 so as to extend radially outward. The ring-shaped collar 3e has a doughnut shape as viewed in plan. A portion between the flange 3c and the ring-shaped collar 3e is a tubular body 3d. The outside diameter of the ring-shaped collar 3e is larger than the outside diameter of the tubular body 3d. As illustrated in FIG. 3, the outside diameter of the tubular body 3d is smaller than the outside diameter of the diaphragm 2 in the present preferred embodiment, although this does not specifically limit the scope of the invention.

The ring-shaped collar 3e and the tubular body 3d may be made of the same material as a single component. In the present preferred embodiment, however, the ring-shaped collar 3e and the tubular body 3d are separate members, and the ring-shaped collar 3e is joined to the end surface of the tubular body 3d that is positioned opposite to the diaphragm 2. Accordingly, the ring-shaped collar 3e may be a different member from the tubular body 3d.

A ring-shaped piezoelectric vibrator 4 is fixed to the surface of the ring-shaped collar 3e that is opposite to the surface closer to the diaphragm 2. The ring-shaped piezoelectric vibrator 4 includes a ring-shaped piezoelectric member and electrodes disposed on respective opposite surfaces of the ring-shaped piezoelectric member. The ring-shaped piezoelectric member is polarized in the thickness direction, in other words, in the direction in which the first end portion 3a and the second end portion 3b of the tube 3 oppose each other. The ring-shaped piezoelectric member is made of a piezoelectric substance, such as piezoelectric ceramics, for example.

The ring-shaped collar 3e and the ring-shaped piezoelectric vibrator 4 fixed thereto define a vibrator that causes the diaphragm 2 to vibrate flexurally. For example, the ring-shaped piezoelectric vibrator 4 has an inside diameter of about 12 mm, an outside diameter of about 18 mm, and a thickness of about 1 mm. The piezoelectric vibrator 4 is driven by rectangular waves with a voltage of about 50 Vpp to about 70 Vpp and a duty ratio of about 50%, for example.

In the bubble generator 1, the flexural vibration of the piezoelectric vibrator 4 is transmitted to the diaphragm 2 through the tube 3, and the vibration of the diaphragm 2 generates the micro bubbles 200. A controller 20 supplies a signal to the electrodes of the piezoelectric vibrator 4, thus driving the piezoelectric vibrator 4. The controller 20 also supplies a signal to the light source 5, thus driving the light source 5.

The piezoelectric vibrator 4 is not limited to the above-described structure including the ring-shaped piezoelectric member and the electrodes disposed on respective opposite surfaces thereof. The piezoelectric vibrator 4 may, for example, include multiple piezoelectric members provided in a ring shape and the electrodes provided on both surfaces of each piezoelectric member.

As illustrated in FIG. 3, the diaphragm 2 is connected to the first end portion 3a of the tube 3 with a support glass 6 interposed therebetween. For example, when the thickness of the diaphragm 2 is about 0.2 mm, the thickness of the support glass member 6 may be about 1.1 mm. The diaphragm 2 may be directly connected to the first end portion 3a of the tube 3 without the support glass 6 therebetween.

The bubble generator 1 is configured such that the diaphragm 2 being in contact with the liquid is defined by the glass plate and the piezoelectric vibrator 4 vibrates the diaphragm 2 via the tube 3. This enables a space to introduce the gas to be completely isolated from the liquid. Complete isolation between the liquid and the space to introduce the gas can prevent electric wiring or the like of the piezoelectric vibrator 4 from coming into contact with the liquid. In addition, in the bubble generator 1, the light source 5 can be provided in the space to introduce the gas, which also prevents electric wiring or the like of the light source 5 from coming into contact with the liquid.

Multiple micro apertures extend through the diaphragm 2. FIG. 4 is a plan view illustrating the diaphragm according to Preferred Embodiment 1. The diaphragm 2 of FIG. 4 is defined by a glass plate 2a having a diameter of about 14 mm in which multiple micro apertures 2b are provided in an approximately 5 mm by 5 mm region at a central portion thereof. For example, when the diameter of each micro aperture 2b is about 10 μm and the spacing between adjacent micro apertures 2b is about 0.25 mm, four hundred and forty one micro apertures 2b can be provided in the 5 mm by 5 mm region of the diaphragm 2. Note that in FIG. 4, the diameter and the spacing of the micro apertures 2b are illustrated differently from actual apertures to provide a picture of many micro apertures 2b being formed in the glass plate 2a.

The diameter of each micro aperture 2b in the diaphragm 2 is, for example, about 1 μm to about 20 μm when measured at the opening of the aperture that comes into contact with the liquid. Introducing air through the micro apertures 2b generates micro bubbles 200 in the water in the water tank 10. A diameter of each micro bubble 200 is, for example, about 10 times larger than the aperture diameter. The micro apertures 2b are arrayed at a spacing of, for example, about 10 times or more larger than the aperture diameter, which prevents micro bubbles 200 generated at one micro aperture 2b from merging other micro bubbles 200 generated at adjacent micro apertures 2b. This improves performance of generating discrete micro bubbles 200.

For example, the micro apertures 2b can be formed to extend through the glass plate 2a using a method in which laser irradiation and liquid-phase etching are combined. More specifically, the glass plate 2a is irradiated with laser beams, and the laser energy denatures the composition of the glass plate 2a. The denatured portion is etched with a liquid fluoride-based etching material to form the micro aperture 2b.

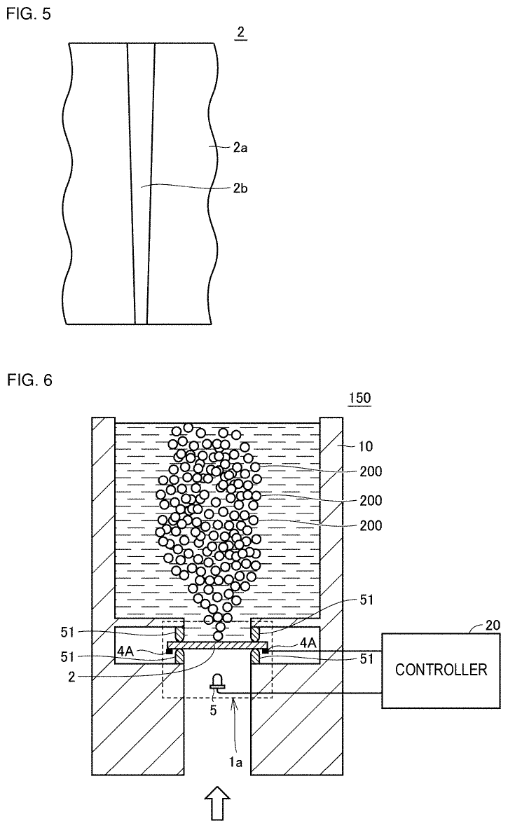

FIG. 5 is a cross-sectional view illustrating a micro aperture (cavity) 2b extending through the diaphragm according to Preferred Embodiment 1. As illustrated in FIG. 5, the micro aperture 2b extending through the glass plate 2a has a tapered shape in which the aperture diameter at the upper surface in the figure is larger than that at the lower surface. The diaphragm 2 is disposed such that the surface with the smaller diameter apertures is in contact with the water in the water tank 10 and the surface with the larger diameter apertures is in contact with the gas, which can further reduce the diameter of each micro bubble 200 generated at the micro aperture 2b. The diaphragm 2 may be disposed oppositely, in other words, the surface with the larger diameter apertures may be in contact with the water in the water tank 10 and the surface with the smaller diameter apertures may be in contact with the gas.

The diaphragm 2 being defined by the glass plate 2a is advantageous compared with a diaphragm defined by a metal plate in that the glass plate 2a can prevent liquid contamination from occurring due to metal ions being leached into the liquid. Moreover, in the case of micro apertures being provided in the metal plate, it is necessary to perform plating to prevent corrosion. It is also necessary to perform plating using a precious metal to prevent leaching of metal ions into the liquid. Precious metal plating on the metal plate including micro apertures increases the cost of the diaphragm.

As described above, the bubble generator 1 according to Preferred Embodiment 1 generates micro bubbles 200 in the liquid by vibration. The bubble generator 1 includes the diaphragm 2, the piezoelectric vibrator 4, and the light source 5. The diaphragm 2 includes the multiple micro apertures 2b extending therethrough and includes the one surface to be in contact with the water (liquid) in the water tank 10 and the other surface to be in contact with the gas. The diaphragm 2 transmits ultraviolet light. The piezoelectric vibrator 4 vibrates the diaphragm 2. The light source 5 emits ultraviolet light to the water (liquid) in the water tank 10 from the side region of the diaphragm 2 near the other surface.

Accordingly, the bubble generator 1 is configured to emit ultraviolet light to the water (liquid) of the water tank (10) from the other side region of the diaphragm 2 that transmits ultraviolet light. With this configuration, the cost and the size of the bubble generator that can generate micro bubbles including ozone can be reduced.

The diaphragm 2 may be defined by the glass plate. Accordingly, the bubble generator 1 can prevent liquid contamination due to metal ions being leached into the water (liquid) in the water tank 10.

The glass plate 2a may be made of a material that transmits ultraviolet light having a wavelength of, for example, about 200 nm to about 380 nm. Accordingly, the bubble generator 1 has a high disinfectant effect due to sterilization by ozone included in the micro bubbles 200 generated by vibration as well as due to sterilization of the water in the water tank 10 by ultraviolet irradiation.

The diaphragm 2 may include micro apertures 2b each of which has a diameter of, for example, about 1 μm to about 20 μm measured at the surface to be in contact with the liquid and that extend through the diaphragm 2 with a spacing between adjacent micro apertures 2b being, for example, about 10 times larger than the diameter. With this configuration, the bubble generator 1 can prevent micro bubbles 200 generated at one micro aperture 2b from merging other micro bubbles 200 generated at adjacent micro apertures 2b, which enables discrete micro bubbles 200 to be generated.

Moreover, each micro aperture 2b has the tapered shape in which the diameter of the micro aperture 2b at the one surface to be in contact with the water (liquid) in the water tank 10 is smaller than the diameter of the micro aperture 2b at the other surface to be in contact with the gas. This enables the bubble generator 1 to further reduce the diameter of each micro bubble 200 generated at the micro aperture 2b.

The bubble generator 1 may further include the tube 3 that includes the first end portion 3a and the second end portion 3b positioned opposite to the first end portion 3a. The tube 3 is connected to the diaphragm 2 at the first end portion 3a so as to support the diaphragm 2. In this case, the piezoelectric vibrator is fixed to the ring-shaped collar 3e that extends radially outward from the tube 3 at a position in a vicinity of the second end portion 3b of the tube 3, and the piezoelectric vibrator 4 vibrates the tube 3. In addition, the first end portion 3a of the tube 3 is joined to the water tank 10.

Accordingly, the bubble generator 1 can completely separate the liquid and the space to introduce the gas from each other, which can thus prevent electric wiring or the like of the piezoelectric vibrator 4 from coming into contact with the liquid.

In addition, the ring-shaped collar 3e includes the first surface positioned closer to the diaphragm 2 and the second surface positioned opposite to the first surface, and the piezoelectric vibrator 4 is fixed to the second surface. Accordingly, the bubble generator 1 can prevent the piezoelectric vibrator 4 from coming into contact with the liquid.

In addition, the tube 3 may include the flange 3c at the first end portion, and the tube 3 may be joined to the water tank 10 with the flange 3c interposed therebetween. Accordingly, the bubble generator 1 can vibrate only the diaphragm 2 without transmitting vibrations from the piezoelectric vibrator 4 to the water tank 10.

Moreover, the flange 3c, the tube 3, and the ring-shaped collar 3e may be integrally made of the same material. This can increase the strength of the flange 3c, the tube 3, and the ring-shaped collar 3e.

### Preferred Embodiment 2

The bubble generator 1 according to Preferred Embodiment 1 has been described as having a structure in which the piezoelectric vibrator 4 vibrates the diaphragm 2 via the tube 3. The structure in which the piezoelectric vibrator vibrates the diaphragm, however, is not limited to this. The structure in which the piezoelectric vibrator vibrates the diaphragm may be different insofar as the bubble generator is configured to emit ultraviolet light to the water (liquid) in the water tank from the other side region of the diaphragm that can transmit the ultraviolet light. A bubble generator according to Preferred Embodiment 2 of the present invention is configured such that the piezoelectric vibrator directly vibrates the diaphragm, which is described further below.

FIG. 6 is a schematic view illustrating a water purifier 150 in which a bubble generator 1a according to Preferred Embodiment 2 is provided. Note that in the bubble generator 1a illustrated in FIG. 6, the same or corresponding components as those described for the bubble generator 1 illustrated in FIGS. 1 to 5 are denoted by the same reference sings, and duplicated descriptions will be omitted.

For example, the bubble generator 1a of FIG. 6 is used in the water purifier 150 to generate micro bubbles 200 in the water in the water tank (liquid tank) 10. The bubble generator 1a is installed at the bottom of the water tank 10. Note that the application of the bubble generator 1a is not limited to the water purifier 150. The bubble generator 1a may be applied to various apparatuses, such as wastewater treatment apparatuses or fish-raising water tanks, for example.

The bubble generator 1a includes the diaphragm 2, a piezoelectric vibrator 4A, and the light source 5. The bubble generator 1a is configured such that the diaphragm 2 is disposed at a hole in a portion of the bottom of the water tank 10 and the end portion of the diaphragm 2 is fixed by rubber seals 51. In the bubble generator 1a, a rubber seal 51 on the surface of the diaphragm 2 that comes into contact with the water (liquid) of the water tank 10 can completely isolate the liquid and the space to introduce the gas from each other.

The piezoelectric vibrator 4A is directly attached to an end portion of the diaphragm 2 and can directly vibrate the diaphragm 2. The diaphragm 2 is fixed by elastic rubber seals 51 and can be vibrated by the piezoelectric vibrator 4A at the end portion of the diaphragm 2.

In the bubble generator 1a, the light source 5 can emit ultraviolet light to the water in the water tank 10 from the side region of the diaphragm 2 in a vicinity of the surface being in contact with air (a gas). Accordingly, in the bubble generator 1a, a back pressure (for example, in an approximate range of about 0.08 atm to about 0.12 atm or about 8 kPa to about 12 kPa) is also applied to the surface of the diaphragm 2 being opposite to the surface in contact with the water (liquid) of the water tank 10. Simultaneously, the light source 5 emits light having a wavelength range of ultraviolet light or deep ultraviolet light. Thus, the water can be sterilized due to both ozone generation and ultraviolet irradiation.

As described above, the bubble generator 1a according to Preferred Embodiment 2 generates micro bubbles 200 in the liquid by vibration. The bubble generator 1a includes the diaphragm 2, the piezoelectric vibrator 4A, and the light source 5. The diaphragm 2 includes the multiple micro apertures 2b extending therethrough and includes the one surface to be in contact with the water (liquid) in the water tank 10 and the other surface to be in contact with the gas. The diaphragm 2 transmits ultraviolet light. The piezoelectric vibrator 4A vibrates the diaphragm 2. The light source 5 emits ultraviolet light to the water (liquid) in the water tank 10 from the side of the diaphragm 2 near the other surface.

Accordingly, the bubble generator 1a is configured to emit ultraviolet light to the water (liquid) of the water tank (10) from the other side region of the diaphragm 2 that transmits ultraviolet light. With this configuration, the cost and the size of the bubble generator that can generate micro bubbles including ozone can be reduced.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A bubble generator that generates micro bubbles in a liquid by vibration, the bubble generator comprising:
a diaphragm including cavities to transmit ultraviolet light, a first surface to be in contact with the liquid in a liquid tank, and a second surface to be in contact with a gas;
a piezoelectric vibrator to vibrate the diaphragm; and
a light source to emit the ultraviolet light to the liquid in the liquid tank from a side region of the diaphragm in a vicinity of the second surface.

2. The bubble generator according to claim 1, wherein the diaphragm includes a glass plate.

3. The bubble generator according to claim 2, wherein the glass plate is made of a material that transmits ultraviolet light having a wavelength of about 200 nm to about 380 nm.

4. The bubble generator according to claim 1, wherein
each of the cavities of the diaphragm has a diameter of about 1 μm to about 20 μm measured at the first surface of the diaphragm to be in contact with the liquid; and
the cavities are provided with a spacing between adjacent cavities being about 10 times greater than the diameter.

5. The bubble generator according to claim 1, wherein each of the cavities has a tapered shape in which a diameter of the cavity at the first surface to be in contact with the liquid in the liquid tank is smaller than a diameter of the cavity at the second surface to be in contact with the gas.

6. The bubble generator according to claim 1, further comprising:
a tube including a first end portion and a second end portion opposite to the first end portion and connected to the diaphragm at the first end portion so as to support the diaphragm; wherein
the piezoelectric vibrator is fixed to a ring-shaped collar extending radially outward from the tube at a position in a vicinity of the second end portion of the tube to vibrate the tube; and
the first end portion of the tube is joined to the liquid tank.

7. The bubble generator according to claim 6, wherein
the ring-shaped collar includes a first surface closer to the diaphragm and a second surface positioned opposite to the first surface and farther from the diaphragm; and
the piezoelectric vibrator is fixed to the second surface.

8. The bubble generator according to claim 6, wherein
the tube includes a flange at the first end portion; and
the tube is joined to the liquid tank with the flange interposed therebetween.

9. The bubble generator according to claim 8, wherein the flange, the tube, and the ring-shaped collar are integrally made of the same material.

10. The bubble generator according to claim 2, wherein the glass plate is made of silica glass or synthetic silica glass.

11. The bubble generator according to claim 6, wherein the tube is made of stainless steel.

12. The bubble generator according to claim 1, wherein the piezoelectric vibrator has a ring shape.

13. The bubble generator according to claim 6, wherein the diaphragm is connected to the tube at the first end portion with a support glass interposed therebetween.

14. The bubble generator according to claim 13, wherein the diaphragm has a thickness of about 0.2 mm, and the support glass has a thickness of about 1.1 mm.

15. The bubble generator according to claim 2, wherein the glass plate has a diameter of about 14 mm, and the cavities are provided in an approximate 5 mm by 5 mm region at a central portion of the glass plate.
